(19) United States
(12) Patent Application Publication
(10) Pub. No.: US 2017/0186170 A1
(43) Pub. Date: Jun. 29, 2017

(54) Facial contour recognition for identification

(71) Applicants: Thomas A. Nugraha, Tokyo (JP); Ramon C. Cancel Olmo, Hillsboro, OR (US); Daniel H. Zhang, Hillsboro, OR (US)

(72) Inventors: Thomas A. Nugraha, Tokyo (JP); Ramon C. Cancel Olmo, Hillsboro, OR (US); Daniel H. Zhang, Hillsboro, OR (US)

(21) Appl. No.: 14/998,064

(22) Filed: Dec. 24, 2015

(51) Int. Cl. G06T 7/00; G06T 15/50; G06K 9/00

(52) U.S. Cl. CPC G06T 7/0073; G06K 9/00281; G06T 7/0067; G06T 15/506; G06K 9/00288; G06T 2207/30201

(57) ABSTRACT

Systems, apparatuses, and/or methods may provide for identifying a face of a user by extracting contour information from images of shadows cast on the face by a facial features illuminated by a controllable source of illumination. The source of illumination may be left, center, and right portions of the light emitting diode (LED) display on a smart phone, tablet, or notebook that has a forward-facing two-dimensional (2D) camera for obtaining the images. In one embodiment, the user is successively photographed under illumination provided using the left, the center, and the right portions of the LED display, providing shadows on the face from which identifying contour information may be extracted and/or determined.

### BACKGROUND

Security concerns may lead to restricted access for facilities (all or in part) of schools, private businesses, government agencies, transportation centers and other places, wherein access may be granted only to individuals who have authorization. Security arrangements may be multi-tiered, including identifying individuals based on appearance. Identification may entail requiring individuals who seek access to walk by a security guard, who then confirms or denies access based on personal knowledge of the appearance of every person to whom access has been granted. A security guard cannot, however, be expected to know everyone to whom access has been granted.

Automated systems that do not require personal knowledge are a part of many systems that control and restrict access to buildings and other facilities where security is of concern. Photographic identification badges may be used to identify individuals, but these may be forged. In addition, a face may form the basis of automatic identification. Three-dimensional (3D) scans taken of a person when entering a facility may be used to compare the appearance of the individual to a database of authorized users. 3D scans, however, typically entail the use of 3D cameras and imagers, which may be prohibitively expensive.

Two-dimensional (2D) cameras and imagers may be employed in pairs to provide data to generate 3D images, but pairs of 2D cameras may be cumbersome to deploy and may cost more than a single 2D camera. A single 2D camera may be used to generate 2D images that may be processed by a computer for automatic identification purposes, but 2D cameras may be relatively simple to defeat. For example, an unauthorized person may attempt to obtain access by presenting a photograph of an individual with access to the 2D camera. On the other hand, 2D cameras offer certain advantages. For example, 2D cameras may be inexpensive and nearly ubiquitous (e.g., present in cell phones, smart phones, etc.).

### BRIEF DESCRIPTION OF THE DRAWINGS

The various advantages of the embodiments will become apparent to one skilled in the art by reading the following specification and appended claims, and by referencing the following drawings, in which:

FIG. 1 is a schematic diagram illustrating a user being imaged under full illumination according to an embodiment;

FIG. 2 is a schematic diagram illustrating a user being imaged using right-side illumination according to an embodiment;

FIG. 3 is a schematic diagram illustrating a user being imaged using left-side illumination according to an embodiment;

FIG. 4 is the schematic diagram of FIG. 2 with additional information according to an embodiment;

FIG. 5 reproduces aspects of FIG. 2 according to an embodiment;

FIG. 6 illustrates geometrical relationships among elements in FIG. 4 according to an embodiment;

FIG. 7 is a block diagram of an example of system including a contour analyzer according to an embodiment;

FIG. 8 is a flowchart of an example of a method of obtaining and analyzing facial contours for user identification according to an embodiment;

FIG. 9 is an example of an integrated system according to an embodiment;

FIGS. 10A-10C are examples of the system of FIG. 9 under several illumination modes according to an embodiment;

FIGS. 11A-11C are examples of shadowing on a user caused by several illumination modes according to an embodiment;

FIGS. 12A-12C are examples of the system of FIG. 9 under several additional illumination modes according to an embodiment; and

FIG. 13 is a block diagram of an example of a computing system according to an embodiment.

### DETAILED DESCRIPTION

In embodiments, contours and three-dimensional (3D) models based on contours may be constructed from data obtained from two-dimensional (2D) images taken of a face of a user as part of an identification process. The images include images of the face of the user that has been sequentially illuminated from its sides, such that features on the face will cast shadows on the face. For example, an image of a face that has been illuminated from the right (directions are presented herein from the perspective of the user) will present shadowing on the left side of the face (e.g., that caused by the nose of the user). Similarly, an image of a face that has been illuminated from the left will present shadowing on the right side of the face. By using geometrical constraints, a height of various facial features at various locations may be computed, and the heights may be used to compute contours of the face to be used to identify a particular user. In this regards, the identity of the user may be confirmed or shown not to match the identity claimed by the user.

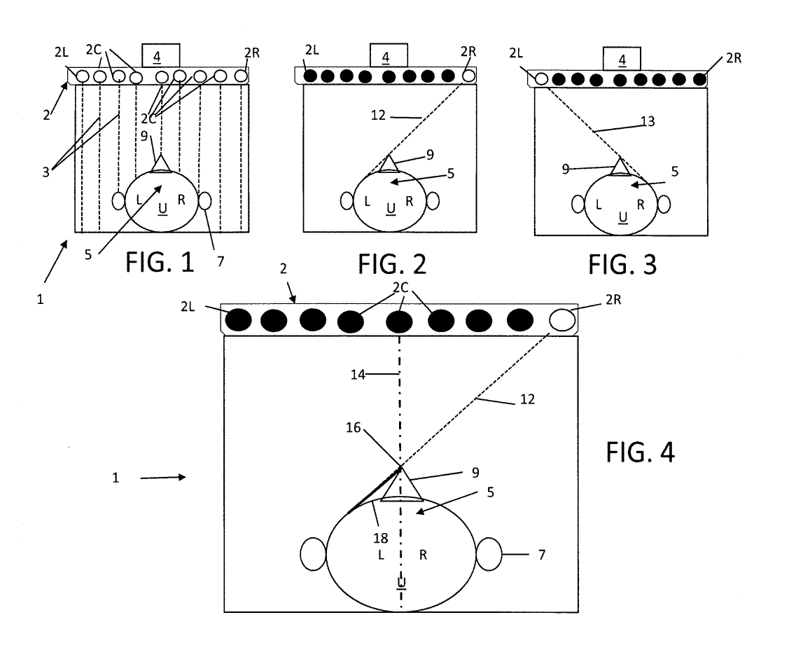

FIGS. 1-3 present an example of an embodiment of an imaging station 1 at which image data is captured of the face 5 of a user U. All relative distances, shapes and sizes shown in FIGS. 1-3 are for illustrative purposes. In the illustrated example, the imaging station 1 has a light source 2 and a 2D camera 4 located at a distance from where a user U is to be positioned (e.g., where an individual may be told to position themselves). The camera 4 may be located immediately above or below the light source 2, or the camera 4 may be at some other positions such as, for example, centrally located and/or remote from the light source 2.

The light source 2 includes a plurality of lights or illumination elements that are selectively controllable. For example, the plurality of lights may be powered on and off individually (e.g., as individually actuatable light bulbs) or in groups. In the illustrated example, the light source 2 is divided into three groups of lighting elements; namely, a left group 2L, a center group 2C, and a right group 2R, wherein each of the groups make up one portion of the light source 2.

As shown in FIGS. 1-3, the left group 2L has one lighting element, the center group 2C has seven lighting elements, and the third group 2R has one lighting element. In some embodiments, however, groups may all have the same number of lighting elements, or a varying number of lighting elements. Moreover, the number of groups of lighting elements may vary. As will be further explained below, in some embodiments the light source 2 may be a light emitting diode (LED) display of a camera, smart phone, tablet computing device, notebook computer, or a mobile Internet device.

As shown in FIG. 1, all of the lights that form the light source 2 are fully illuminated, and may be set to a maximum level of brightness. Thus, when the user U faces the light source 2 directly, no shadows may be cast by the facial features of the user U, such as ears 7 or a nose 9. At this point, the camera may capture a reference image of the face 5 of the user U, which may be fully illuminated.

As shown in FIG. 2, the lights of the left group 2L and the center group 2C have been powered off, and the lights of the right group 2R (in this embodiment, there is only one light in groups 2R and 2L) remain powered on, so that the face 5 of the user U is illuminated from the right, and the camera 4 captures an image of the face 5 while it is illuminated in the arrangement. The illumination provided by the right group 2R will tend to cause various features on the face 5 of user U to cast shadows on the left side of the face 5. Features that may cast shadows include the nose 9, the ears 7, as well as other features such as a mouth, lips, chin, eye sockets, cheeks, forehead, and so on. Other features, such as eyeglasses of the user U, may also cause shadowing. In this regard, the user U may be required to remove the eyeglasses before proceeding.

Facial shadows may be regarded as a locally 2D phenomenon created by a 3D feature, such as a nose, on a sufficiently small scale. For example, a shadow cast by a nose is to some degree reflective of the particular profile of the user's 3D nose, which may be regarded as consisting of a series of contiguous features, each having a characteristic height above the general plane of the user's face. As shown in FIG. 2, a tangent ray 12 may correspond to a ray of light from the right group 2R that just touches the bridge of the nose 9 of the user U, and marks the boundary of a shadow cast by the nose 9 on the left side of the face 5. Such tangent rays may be considered along multiple transverse planes with respect to the bridge of the nose 9, and their points of intersection with the face 5 may collectively mirror, albeit in a somewhat distorted form, the profile of the nose 9.

As shown in FIG. 3, the lights of the right group 2R and the center group 2C have been switched off. The lights of left group 2L are powered on, such that the face 5 of the user U is illuminated from the left, and the camera 4 captures an image of face 5 while the face 5 is illuminated in this arrangement. The illumination provided by the lights of the left group 2L may cause various features on the face 5 of user U to cast shadows onto the right side of the face 5. A tangent ray 13 may correspond to a ray of light from the left group 2L that just touches the bridge of the nose 9 of the user U, and marks the boundary of a shadow cast by the nose 9 on the right side of the face 5. Such tangent rays may be considered along multiple transverse planes with respect to the bridge of the nose 9, and their points of intersection with the face 5 may collectively mirror, albeit in a somewhat distorted form, the profile of the nose 9.

Human faces tend to have various asymmetries, such that shadowing caused by illumination on the right side of a face may not be identical to shadowing caused by illumination on a left side of the face. In this regard, separate images under both left side and right side illumination of the face 5 may be captured. Facial asymmetries represent additional data that may be used to increase the confidence that a particular user has been identified. In some embodiments where a lesser degree of certainty identifying user features is required, a system may exclude imaging under left or right side illumination, and instead image a face under only one or the other form of side illumination.

The arrangement shown in FIG. 4 is similar to FIG. 2, and shows additional detail including a shadow 18 cast by the nose 9. The face 5 of the user U is divided into a left half L and a right half R along a center line 14 (generally lying within the sagittal plane of the user U). The nose 9, at the point 16 along its bridge, has a height h (FIG. 6), and casts a shadow 18 on the face 5 of the user U. Other features may also cast shadows, such as the ears 7, eye sockets, cheeks, chin, etc., which have not been depicted for ease of illustration.

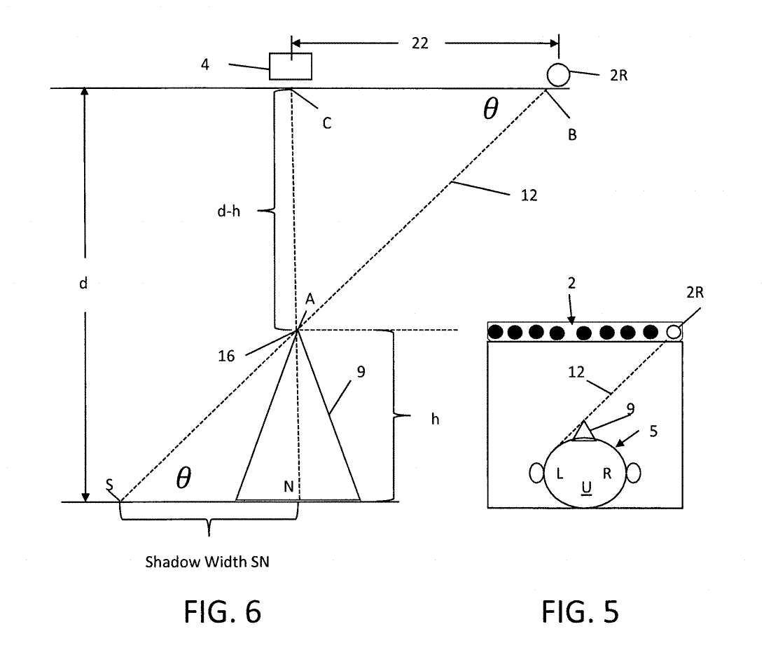

FIG. 5 reproduces aspects of FIG. 2 to facilitate discussion of FIG. 6, which highlights one or more geometrical parameters of the face 5 of the user U, the camera 4, and the lights of the right group 2R (here shown as having one light). As shown in FIG. 6, the region of the face 5 immediately local to the nose 9 is shown as flat for illustration, although the region may be curved. As noted above, tangent ray 12 marks the outer boundary at S of a shadow 18 cast by the nose 9 starting at the point 16. In the illustrated example, the shadow has a width SN.

The width SN of the shadow (e.g., in centimeters) may be determined by consideration of a pixel width PW, which is known, a camera width CW (e.g., in centimeters) of the image visible to the camera 4 at a depth d, a width of an image taken by camera 4 at the depth d in terms of number of pixels N the image spans, and a pixel shadow width PSW that provides the width SN of the shadow in terms of its extent in pixels, which may be read off or computed from an image.

Specifically:

$$\begin{matrix}SN \text{/} CW = PSW \text{/} N & ( Equation 1 ) \\ or \text{:} & \\ SN = ( \frac{CW}{N} ) \cdot PSW = PW \cdot PSW & ( Equation 2 )\end{matrix}$$

The point 16 along the bridge of the nose 9 that casts shadow 18 has an unknown feature height h. However, sufficiently other dimensions may be known to calculate the feature height h. The distance d from the face 5 of user U to the camera 4 may be measured in advance (e.g., the user may be directed to stand at a specific place that is a known distance in front of the camera 4), or may correspond to a known focal point of the camera 4 when focused on the face 5 of the user U. A distance 22 from the approximate center of the lights of the right group 2R to the lens of the camera 4 may also be known. When user U faces directly into the camera 4, a line CAN may be drawn that is orthogonal both to the plane of camera 4 and to the face 5 of the user U. The line CAN may be further divided into a segment AN having a length corresponding to the feature height h, and a segment CA having a length d-h.

The geometric arrangement of the width SN of the shadow, the point 16 of nose 9, the camera 4, the point S, and the location of the right group 2R may be presented as two similar right triangles CAB and SAN. Also, an angle CBA =angle NSA =θ.

Using principles of plane geometry, it may be determined that:

(d−h)/h=CB/SN Equation 3

which can be solved for h:

h=(d·SN)/(CB +SN) Equation 4

Another relationship which may be useful in computing a feature height h involves the alternate interior angle θ in FIG. 6, since it may be more convenient in some implementations to proceed from a computed determination of θ:

$$\begin{matrix}θ = tan ( \frac{h}{SN} ) & ( Equation 5 ) \\ or \text{:} & \\ h = SN \cdot arctan ( θ ) & ( Equation 6 )\end{matrix}$$

Thus, a value for a feature height h may be computed from knowledge of the width SN of the shadow, the spacing between the camera 4 and the lights of the right group 2R (or other group), and the distance d. Feature heights h may be determined in this manner from shadows resulting from images taken during illumination on the right side as well as from shadows resulting from images taken during illumination on the left side. Each image may result in a slightly different value for feature height h, either because the user U is not looking directly at the camera 4, or because of facial asymmetries. The two values for the feature height h may be averaged together to provide a single feature height h.

While one value of a feature height h may be helpful in confirming (or excluding) an identity of a user, a series of feature heights may be computed from the shadow 18, each corresponding to different points along the bridge of the nose 9. The series of feature heights may be used to construct a contour of the bridge of the nose 9. Nose contours and the contours of other features on the face 5 of the user U that may cast shadows may be used to identify a particular user.

In some embodiments, separate contours may be constructed of the nose 9 using left and right extending shadows. In this regard, the separate contours may be used to characterize a feature, such as the profile of the bridge of the nose 9.

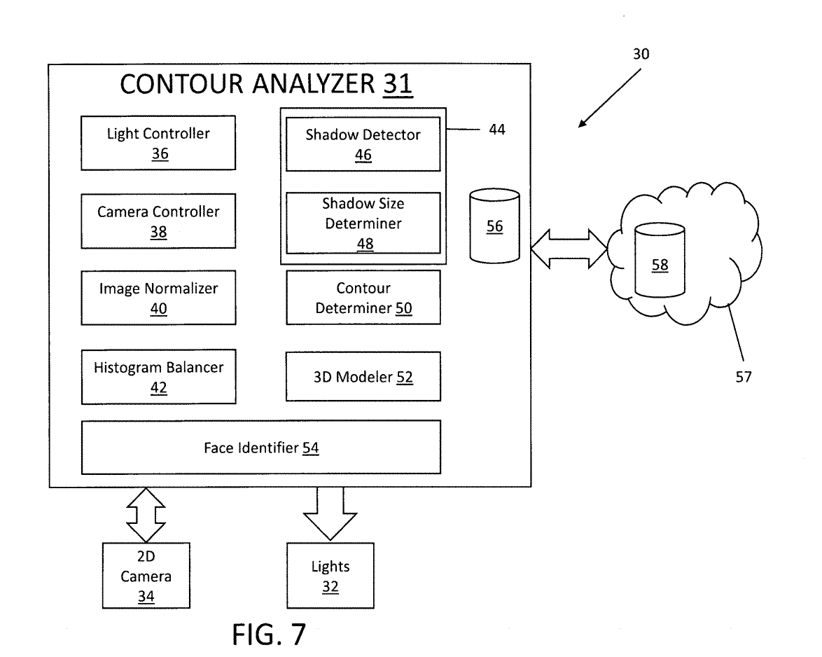

FIG. 7 shows a block diagram of an embodiment of a system 30 having a contour analyzer 31 to generate and analyze contours determined from shadows. The contour analyzer 31 includes a light controller 36 to selectively control the individual lighting elements within the lights 32, such as by powering on some lights but not others. The lights 32 may provide selective illumination that may be brief (e.g., flash, etc.) or of longer duration.

A camera controller 38 synchronizes and controls a 2D camera 34 with respect to the lights 32 including providing timing of the camera 34 and control over its autofocus features (including determination of a distance of the camera to a user) and autoprocessing features where available. An image normalizer 40 is provided to normalize image data, and a histogram balancer 42 is provided to balance histograms of image data.

The contour analyzer 31 further includes a shadow analyzer 44 to analyze shadows cast on a face of a user, discussed above. The shadow analyzer 44 may include a shadow detector 46 to detect shadows. Shadow detection may be accomplished in several ways, including by image subtraction. For example, subtracting an image having shadows, such as images obtained by a camera during a selective activation of left group lights or right group lights, from the generally shadow-free images obtained when the lights of a center group are illuminated, may provide an image in which the shadows may readily be identified. The shadow size determiner 48 measures a width and other in-image-plane dimensions of the shadow, and computes a height of features creating the shadow (e.g., Equations 1-6). The contour determiner 50 may use the feature height information to determine contours for the features.

A 3D modeler 52 may be provided to generate 3D models of the face of the user based on the contours. In addition, a face identifier 54 determines whether the facial contours computed for the face of a given user sufficiently match contour information stored either in local memory 56 or in a remote database 58, which may be accessed via cloud 57. If a suitable match is found, then identification may be established. If no match is found, then the data is entered into the local memory 56, the database 58, or other memory location, and access to a restricted facility may be denied to the user.

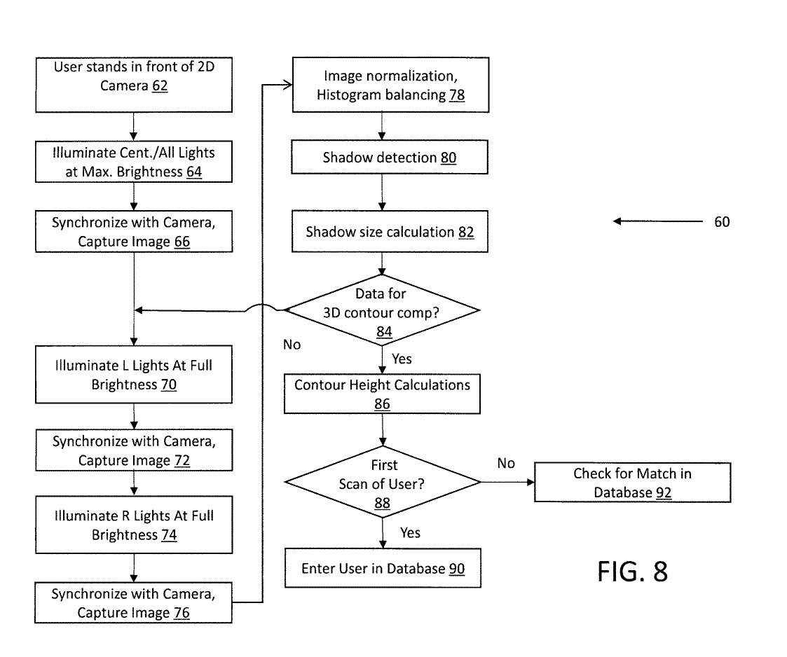

FIG. 8 shows a flowchart of an example of a method 60 of using images provided by a 2D camera to generate 3D contours that may be used to identify a user. The method 60 may be implemented in one or more modules as a set of logic instructions stored in a machine- or computer-readable storage medium such as random access memory (RAM), read only memory (ROM), programmable ROM (PROM), flash memory, etc., as configurable logic such as, for example, programmable logic arrays (PLAs), field programmable gate arrays (FPGAs), complex programmable logic devices (CPLDs), as fixed-functionality logic hardware using circuit technology such as, for example, application specific integrated circuit (ASIC), complementary metal oxide semiconductor (CMOS) or transistor-transistor logic (TTL) technology, or any combination thereof. For example, computer program code to carry out operations shown in the method 60 may be written in any combination of one or more programming languages, including an object oriented programming language such as C++or the like and conventional procedural programming languages, such as the “C” programming language or similar programming languages. Moreover, the method 60 may be implemented using any of the herein mentioned circuit technologies.

Illustrated processing block 62 prompts a user to stand in front of a 2D camera having selectively controllable lights, for example as described above with respect to left, center, and right groups of lights. Illustrated processing block 64 activates all of the lights, wherein the face of the user is fully illuminated in direct light. In some embodiments, not all of the lights may be activated, but instead only a central portion of the lights may be powered on to provide illumination. Illustrated processing block 66 synchronizes the lights with the camera (e.g., in the event flash photography is employed) and a facial image is captured.

Illustrated processing block 70 powers off all of the lights except for those on the left (e.g. 2L in FIG. 3), discussed above. The left lights are set to their full brightness, although in some embodiments the left side lights may be set to a lesser brightness depending on, for example, the lighting available and on ambient lighting conditions. Illustrated processing block 72 synchronizes the lights with the camera, and a facial image is captured.

Illustrated processing block 74 powers off all of the lights except for those on the right (e.g. 2R in FIG. 2), discussed above. The right lights are set to their full brightness, although in some embodiments the right side lights may be set to a lesser brightness depending on the lighting available and on ambient lighting conditions. Illustrated processing block 76 synchronizes the lights with the camera, and a third facial image is captured.

Illustrated processing block 78 normalizes the image data and performs histogram balancing on the image data. Illustrated processing block 80 performs shadow detection, which, as noted above, may be performed by subtracting the images obtained with left or right side illumination from the image obtained with center illumination. Illustrated processing block 82 calculates a size of the shadow and may, in some embodiments, also determine a height of the feature that form the shadow, for example as discussed above with reference to FIG. 6.

Block 84 determines whether enough data has been presently obtained to compute desired 3D contours of features on the face of the user. If not, then control passes back to block 70, and additional images may be taken. If the data obtained is sufficient, then illustrated processing block 86 calculates contour heights, in some embodiments where not already done at block 82. In addition, contour lines may be generated.

Block 88 determines if the user has been scanned before. This may be done, in part, by asking the user if the user has authorization to enter. If the process is for a first scan, then the user data and other identifying information (e.g., the user's name, social security number, photographic images, etc.) may be entered into a database at illustrated processing block 90. If the user asserts that this is not the first scan, and that the user has authorization to enter, then a search is made of any available databases to see if there is a sufficient match between the contour information just generated of the user and contour information in the database. If no match is found, then the user may be denied access. If, a match is found, then access may be granted, or other security measures (such as a request for a password, key card, etc.) may be implemented.

Methods disclosed herein may use white light, color, or combinations of color and white light. Moreover, the use of a 2D camera permits especially compact and self-contained systems. Indeed, the system may be contained entirely within the form factor of a tablet, a phablet, a notebook, or a smart phone having an LED display. Notably, such devices and similar portable device typically have forward (i.e., user-side) facing cameras and bright LED displays.

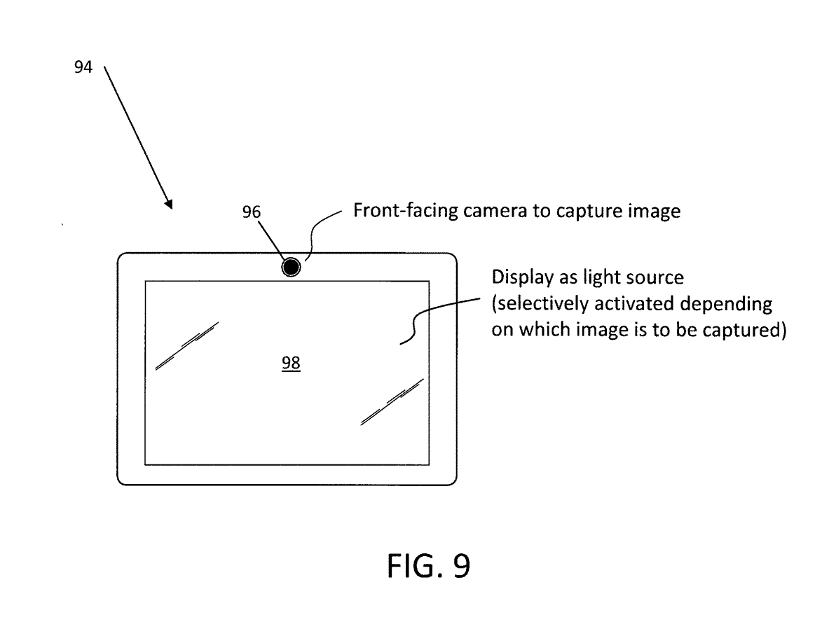

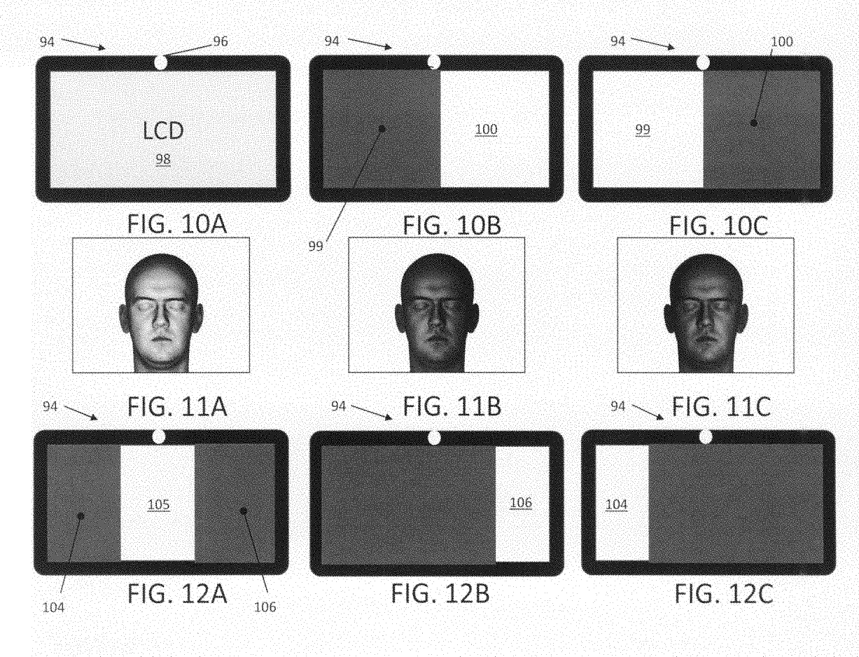

FIG. 9 shows an embodiment of a system in which a contour analyzer, such as the contour analyzer 31 (FIG. 7), discussed above, is part of a portable device 94, which may be a tablet, a phablet, a notebook, a camera having data processing capabilities, a gaming device, a smart phone, a mobile Internet device, and so on. The portable device 94 has a forward facing camera 96 to capture images of users illuminated by a display 98 (e.g., LED). As shown in FIGS. 10A-10B, the display 98 is shown in three states of illumination (apart from completely “OFF”). In FIG. 10A, the display 98 is fully illuminated at its maximum level of brightness, and the portable device 94 may be used to capture centrally illuminated images such as are depicted in FIG. 1, discussed above, and in FIG. 11A, in which the user faces the portable device 94.

In FIG. 10B, the display 98 is divided into a left side 99 that is unlit and a right side 100 that is fully illuminated, set to its maximum level of brightness, and the portable device 94 may be used to capture images as depicted in FIG. 2, discussed above, and in FIG. 11B.

In FIG. 10C, the LED display is divided into a left side 99 that is fully illuminated, set to its maximum level of brightness, and a right side 100 that is unlit, and the portable device 94 may be used to capture images as depicted in FIG. 3, discussed above, and in FIG. 11C.

Turning now to FIGS. 12A-12C, the portable device 94 presents a different arrangement for illuminating the display 98 according to another embodiment, in which the display 98 has three selectively actuatable portions; namely, a left portion 104 (shown in a fully illuminated state in FIG. 12C), a center portion 105 (shown in a fully illuminated stated in FIG. 12A), and a right portion 106 (shown in a fully illuminated state in FIG. 12B). The illumination provided by the portable device 94 in FIG. 12A may be comparable to that shown with respect to FIG. 11A. The illumination provided in FIG. 12B may be comparable to that shown with respect to FIG. 11B. Also, the illumination provided in FIG. 12C may be comparable to that shown with respect to FIG. 11C. Other combinations of lighting arrangements are possible, and may be provided for by software, firmware, or hardware in the portable device that controls illumination of the display 98. Moreover, pixels may be controlled to provide specialized color values other than white for imaging purposes.

Embodiments may include, or be incorporated within a server-based gaming platform, a game console, including a game and media console, a mobile gaming console, a handheld game console, or an online game console. In some embodiments, the portable device 94 may be a mobile phone, a smart phone, a tablet computing device, a notebook computer, or a mobile Internet device. Portable device 94 may also include, couple with, or be integrated within a wearable device, such as a smart watch wearable device, smart eyewear device, augmented reality device, or virtual reality device. In some embodiments, the portable device 94 is part of a television or set top box device having one or more processors and a graphical interface generated by one or more graphics processors.

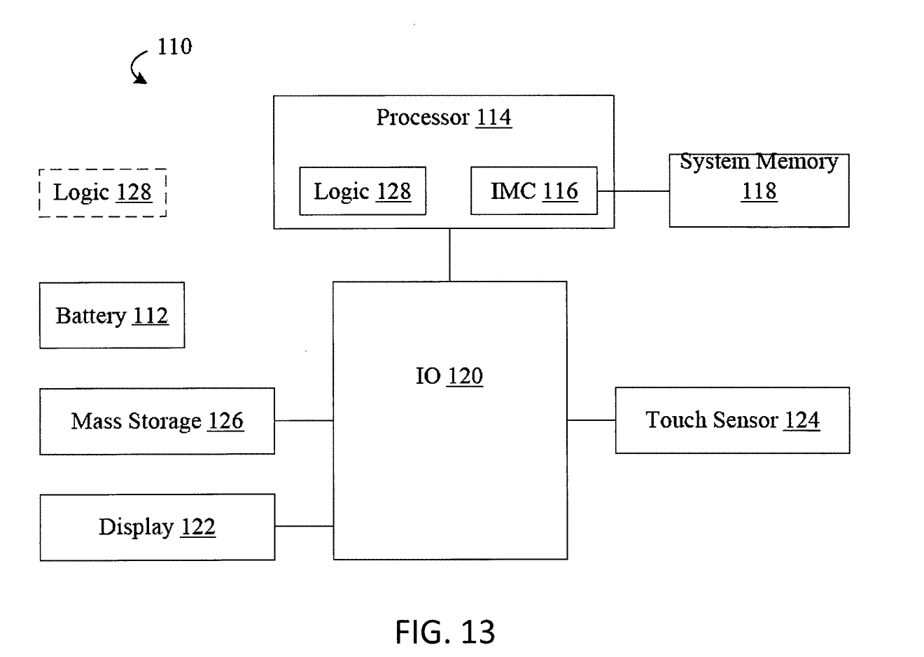

Turning now to FIG. 13, a computing device 110 is illustrated according to an embodiment. The computing device 110 may be part of a platform having computing functionality (e.g., personal digital assistant/PDA, notebook computer, tablet computer), communications functionality (e.g., wireless smart phone), imaging functionality, media playing functionality (e.g., smart television/TV), wearable functionality (e.g., watch, eyewear, headwear, footwear, jewelry) or any combination thereof (e.g., mobile Internet device/MID). In the illustrated example, the device 110 includes a battery 112 to supply power to the device 110 and a processor 114 having an integrated memory controller (IMC) 116, which may communicate with system memory 118. The system memory 118 may include, for example, dynamic random access memory (DRAM) configured as one or more memory modules such as, for example, dual inline memory modules (DIMMs), small outline DIMMs (SODIMMs), etc.

The illustrated device 110 also includes a input output (I/O) module 120, sometimes referred to as a Southbridge of a chipset, that functions as a host device and may communicate with, for example, a display 122 (e.g., touch screen, liquid crystal display/LCD, light emitting diode/LED display), a touch sensor 124 (e.g., a touch pad, etc.), and mass storage 126 (e.g., hard disk drive/HDD, optical disk, flash memory, etc.). The illustrated processor 114 may execute logic 128 (e.g., logic instructions, configurable logic, fixed-functionality logic hardware, etc., or any combination thereof) configured to function similarly to the imaging station 1 (FIG. 1), the contour analyzer 31, and so on.

### ADDITIONAL NOTES AND EXAMPLES

Example 1 may include a system to determine facial contours of a user, comprising a light source having a left portion, a center portion, and a right portion, wherein each of the portions is selectively controllable to provide selective illumination of a face of a user, a 2-dimensional (2D) camera having an imager to provide image data of the face under the selective illumination, a light source controller to control the light source, and a contour analyzer to analyze shadows cast by features on the face under the selective illumination provided by the portions, wherein the contour analyzer is to compute contours of the face based on the shadows.

Example 2 may include the system of Example 1, wherein the light source is to include a light emitting diode (LED) display integral with the camera.

Example 3 may include the system of any one of Examples 1 to 2, further including a shadow analyzer to, detect the shadows, determine a size of the shadows, and compute a height of the features that are to cast the shadows.

Example 4 may include the system of any one of Examples 1 to 3, further including at least one of, an image normalizer to normalize the image data, or an image histogram balancer to balance a histogram of the image data.

Example 5 may include the system of any one of Examples 1 to 4, further including, a contour determiner to determine the contours from a height of the features that are to cast the shadows, and a three-dimensional (3D) modeler that is to construct a model of the face based on the contours.

Example 6 may include the system of any one of Examples 1 to 5, further including a face identifier to identify the user based on at least one of the contours or the 3D model.

Example 7 may include an apparatus to determine facial contours of a user, comprising a light source controller to control a light source having a left portion, a center portion, and a right portion, wherein each of the portions is selectively controllable to provide selective illumination of a face of a user, a camera controller to control a 2-dimensional (2D) camera having an imager to provide image data of the face under the selective illumination, and a contour analyzer to analyze shadows cast by features on the face under the selective illumination provided by the portions, wherein the contour analyzer is to compute contours of the face based on the shadows.

Example 8 may include the apparatus of Example 7 wherein the light source is to include a light emitting diode (LED) display integral with a camera.

Example 9 may include the apparatus of any one of Examples 7 to 8, further including a shadow analyzer to, detect the shadows, determine a size of the shadows, and compute a height of the features that are to cast the shadows.

Example 10 may include the apparatus of any one of Examples 7 to 9, further including at least one of, an image normalizer to normalize the image data, or an image histogram balancer to balance a histogram of the image data.

Example 11 may include the apparatus of any one of Examples 7 to10, further including a contour determiner to determine the contours from a height of the features that are to cast the shadows, and a three-dimensional (3D) modeler that is to construct a model of the face based on the contours.

Example 12 may include the apparatus of any one of Examples 7 to 11, further including a face identifier to identify the user based on at least one of the contours or the 3D model.

Example 13 may include a method to determine facial contours of a user, comprising selectively illuminating portions of a face of a user by selectively activating portions of a light source including a left portion, a center portion, and a right portion, generating image data of the face under selective illumination, analyzing shadows cast by features on the face under the selective illumination provided by the portions of the light source, and computing contours of the face based on the shadows.

Example 14 may include the method of Example 13, wherein the light source includes a light emitting diode (LED) display integral with a camera that generates the image data.

Example 15 may include the method of any one of Examples 13 to14, further including detecting the shadows, determining a size of the shadows, and computing a height of the features casting the shadows.

Example 16 may include the method of any one of Examples 13 to15, further including at least one of normalizing the image data, or balancing a histogram of the image data.

Example 17 may include the method of any one of Examples 13 to 16, further including determining the contours from a height of the features casting the shadows, and constructing a three-dimensional (3D) model of the face based on the contours.

Example 18 may include the method of any one of Examples 13 to17, further including identifying the user based on at least one of the contours or the 3D model.

Example 19 may include at least one computer readable storage medium comprising a set of instructions, which when executed by an apparatus, cause the apparatus to selectively illuminate portions of a face of a user by selectively activating portions of a light source including a left portion, a center portion, and a right portion, generate image data of the face under selective illumination, analyze shadows cast by features on the face under the selective illumination provided by the portions of the light source, and compute contours of the face based on the shadows.

Example 20 may include the at least one computer readable storage medium of Example 19, wherein the light source is to include a light emitting diode (LED) display integral with a camera that generates the image data.

Example 21 may include the at least one computer readable storage medium of any one of Examples 19 to 20, wherein the instructions, when executed, cause the apparatus to detect the shadows, determine a size of the shadows, and compute a height of features casting the shadows.

Example 22 may include the at least one computer readable storage medium of any one of Examples 19 to 21, wherein the instructions, when executed, cause the apparatus to at least one of normalize the image data, or balance a histogram of the image data.

Example 23 may include the at least one computer readable storage medium of any one of Examples 19 to 22, wherein the instructions, when executed, cause the apparatus to determine the contours from a height of the features casting the shadows, and construct a three-dimensional (3D) model of the face based on the contours.

Example 24 may include the at least one computer readable storage medium of any one of Examples 19 to 23, wherein the instructions, when executed, cause the apparatus to identify the user based on at least one of the contours or the 3D model.

Example 25 may include an apparatus to determine facial contours of a user, comprising means for selectively illuminating portions of a face of a user by selectively activating portions of a light source including a left portion, a center portion, and a right portion, means for generating image data of the face under selective illumination, means for analyzing shadows cast by features on the face under the selective illumination provided by the portions of the light source, and means for computing contours of the face based on the shadows.

Example 26 may include the apparatus of Example 25, wherein the light source includes a light emitting diode (LED) display integral with a camera that generates the image data.

Example 27 may include the apparatus of any one of Examples 25 to 26, further including means for detecting the shadows, determining a size of the shadows, and computing a height of the features casting the shadows.

Example 28 may include the apparatus of any one of Examples 25 to 27, further including means for at least one of normalizing the image data or balancing a histogram of the image data.

Example 29 may include the apparatus of any one of Examples 25 to 28, further including means for determining the contours from a height of the features casting the shadows, and means for constructing a three-dimensional (3D) model of the user's face based on the contours.

Example 30 may include the apparatus of any one of Examples 25 to 29, further including means for identifying the user based on at least one of the contours or the 3D model.

Example 31 may include an apparatus to determine facial contours of a user, comprising a light emitting diode (LED) display having a left portion, a center portion, and a right portion, wherein each of the portions is selectively controllable to provide selective illumination of a face of a user, a 2-dimensional (2D) camera having an imager to provide image data of the face under the selective illumination, a light source controller to control the light source, and a contour analyzer that is to analyze shadows cast by features on the face under the selective illumination provided by the portions, wherein the contour analyzer is to compute contours of the face based on the shadows.

Example 32 may include the apparatus of Example 31, wherein the apparatus is to include a smart phone.

Example 33 may include the apparatus of any one of Examples 31 to 32, further including a shadow analyzer that is to, detect the shadows, determine a size of the shadows, and compute a height of the features that are to cast the shadows.

Example 34 may include the apparatus of any one of Examples 31 to 33, further including at least one of an image normalizer to normalize the image data, or an image histogram balancer to balance a histogram of the image data.

Example 35 may include the apparatus of any one of Examples 31 to 34, further including a contour determiner to determine the contours from a height of the features that are to cast the shadows, and a three-dimensional (3D) modeler that is to construct a model of the face based on the contours.

Example 36 may include the apparatus of any one of Examples 31 to 35, further including a face identifier to identify the user based on at least one of the contours or the 3D model.

Example 37 may include the apparatus of any one of Examples 31 to 36, further including a memory to store at least of the contours or the 3D model.

Example 38 may include a method to confirm the identify of a user from the user's facial contours comprising creating a database of user facial contours by selectively illuminating portions of a face of a user by selectively activating portions of a light source including a left portion, a center portion, and a right portion, generating image data of the face under selective illumination, analyzing shadows cast by features the face under the selective illumination provided by portions of the light source, and computing contours of the face based on the shadows, and determining if a user's facial contours match contours in the database.

Example 39 may include the method of Example 38, wherein the light source includes a light emitting diode (LED) display integral with a camera that generates the image data.

Example 40 may include the method of any one of Examples 38 to 39, further including detecting the shadows, determining a size of the shadows, and computing a height of the features casting the shadows.

Example 41 may include the method of any one of Examples 38 to 40, further including determining the contours from a height of the features casting the shadows, and constructing a three-dimensional (3D) model of the face based on the contours.

Example 42 may include the method of any one of Examples 38 to 41, further including identifying a user based on at least one of the contours or the 3D model.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” or “at least one of” may mean any combination of the listed terms. For example, the phrases “one or more of A, B or C” may mean A; B; C; A and B; A and C; B and C; or A, B and C. In addition, a list of items joined by the term “and so forth” or “etc.” may mean any combination of the listed terms as well any combination with other terms.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

1. A system comprising:
a light source having a left portion, a center portion, and a right portion, wherein each of the portions is selectively controllable to provide selective illumination of a face of a user;
a 2-dimensional (2D) camera having an imager to provide image data of the face under the selective illumination;
a light source controller to control the light source; and
a contour analyzer to analyze shadows cast by features on the face under the selective illumination provided by the portions, wherein the contour analyzer is to compute contours of the face based on the shadows; and
a shadow analyzer to:
detect the shadows;
determine a size of the shadows; and
compute a height of the features that cast the shadows.

2. The system of claim 1, wherein the light source is to include a light emitting diode (LED) display integral with the camera.

3. (canceled)

4. The system of claim 1, further including at least one of,
an image normalizer to normalize the image data, or
an image histogram balancer to balance a histogram of the image data.

5. The system of claim 1, further including,
a contour determiner to determine the contours from a height of the features that cast the shadows, and
a three-dimensional (3D) modeler that is to construct a model of the face based on the contours.

6. The system of claim 5, further including a face identifier to identify the user based on at least one of the contours or the 3D model.

7. An apparatus comprising:
a light source controller to control a light source having a left portion, a center portion, and a right portion, wherein each of the portions is selectively controllable to provide selective illumination of a face of a user;
a camera controller to control a 2-dimensional (2D) camera having an imager to provide image data of the face under the selective illumination;
a contour analyzer to analyze shadows cast by features on the face under the selective illumination provided by the portions, wherein the contour analyzer is to compute contours of the face based on the shadows; and
a shadow analyzer to:
detect the shadows;
determine a size of the shadows; and
compute a height of the features that cast the shadows.

8. The apparatus of claim 7, wherein the light source is to include a light emitting diode (LED) display integral with a camera.

9. (canceled)

10. The apparatus of claim 7, further including at least one of,
an image normalizer to normalize the image data, or
an image histogram balancer to balance a histogram of the image data.

11. The apparatus of claim 7, further including:
a contour determiner to determine the contours from a height of the features that cast the shadows; and
a three-dimensional (3D) modeler that is to construct a model of the face based on the contours.

12. The apparatus of claim 11, further including a face identifier to identify the user based on at least one of the contours or the 3D model.

13. A method comprising:
selectively illuminating portions of a face of a user by selectively activating portions of a light source including a left portion, a center portion, and a right portion;
generating image data of the face under selective illumination;
detecting shadows cast by features on the face under the selective illumination provided by the portions of the light source;
analyzing the shadows, including:
determining a size of the shadows; and
computing a height of the features casting the shadows; and
computing contours of the face based on the shadows.

14. The method of claim 13, wherein the light source includes a light emitting diode (LED) display integral with a camera that generates the image data.

15. (canceled)

16. The method of claim 13, further including at least one of:
normalizing the image data; or
balancing a histogram of the image data.

17. The method of claim 13, further including:
determining the contours from a height of the features casting the shadows; and
constructing a three-dimensional (3D) model of the face based on the contours.

18. The method of claim 17, further including identifying the user based on at least one of the contours or the 3D model.

19. At least one computer readable storage medium comprising a set of instructions, which when executed by an apparatus, cause the apparatus to:
selectively illuminate portions of a face of a user by selectively activating portions of a light source including a left portion, a center portion, and a right portion;
generate image data of the face under selective illumination;
detect shadows cast by features on the face under the selective illumination provided by the portions of the light source;
analyze the shadows, including:
determine a size of the shadows; and
compute a height of the features casting the shadows; and
compute contours of the face based on the shadows.

20. The at least one computer readable storage medium of claim 19, wherein the light source is to include a light emitting diode (LED) display integral with a camera that generates the image data.

21. (canceled)

22. The at least one computer readable storage medium of claim 19, wherein the instruction, when executed, cause the apparatus to at least one of
normalize the image data; or
balance a histogram of the image data.

23. The at least one computer readable storage medium of claim 19, wherein the instruction, when executed, cause the apparatus to:
determine the contours from a height of the features casting the shadows; and
construct a three-dimensional (3D) model of the face based on the contours.

24. The at least one computer readable storage medium of claim 23, wherein the instruction, when executed, cause the apparatus to identify the user based on at least one of the contours or the 3D model.
